(19) United States
(12) Patent Application Publication
(10) Pub. No.: US 2006/0028421 A1
(43) Pub. Date: Feb. 9, 2006

(54) Gate line driving circuit

(76) Inventors: Tetsuya Nakamura, Moriguchi-shi (JP); Seiji Kawaguchi, Hirakata-shi (JP); Masahiko Takeoka, Yamatokoriyama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/197,395

(22) Filed: Aug. 5, 2005

(30) Foreign Application Priority Data
Aug. 6, 2004 (JP) 2004-231106

(51) Int. Cl. G09G 3/36

(52) U.S. Cl. 345/99

(57) ABSTRACT

A gate line driving circuit includes a plurality of OR gate circuits which selects each of at least two groups obtained by dividing gate lines, and a level shifter which outputs driving signals to the gate lines of a group that is selected by the OR gate circuits. The OR gate circuits are configured such that the groups of gate lines are selected at different timings in an initialization for transferring the OCB liquid crystal pixels from a splay alignment to a bend alignment upon supply of power.

### CROSS-REFERENCE TO RELATED APPLICATIONS

This application is based upon and claims the benefit of priority from prior Japanese Patent Application No. 2004-231106, filed Aug. 6, 2004, the entire contents of which are incorporated herein by reference.

### BACKGROUND OF THE INVENTION

1. Field of the Invention

The present invention relates to a gate line driving circuit that is applied to an OCB (Optically Compensated Birefringence) mode liquid crystal display panel.

2. Description of the Related Art

Flat-panel display devices, which are typified by liquid crystal display devices, have widely been used as display devices for computers, car navigation systems, TV receivers, etc.

The liquid crystal display device generally includes a liquid crystal display panel including a matrix array of liquid crystal pixels, and a display panel control circuit that controls the display panel. The liquid crystal display panel is configured such that a liquid crystal layer is held between an array substrate and a counter substrate.

The array substrate includes a plurality of pixel electrodes that are arrayed substantially in a matrix, a plurality of gate lines that are arranged along rows of the pixel electrodes, a plurality of source lines that are arranged along columns of the pixel electrodes, and a plurality of switching elements that are arranged near intersections between the gate lines and the source lines. Each of the switching elements is formed of, e.g. a thin-film transistor (TFT), and turned on to apply a potential of one source line to one pixel electrode when one gate line is driven. On the counter substrate, a common electrode is provided to face the pixel electrodes arrayed on the array substrate. Each pair of pixel electrode and common electrode is associated with a pixel area of the liquid crystal layer to form a pixel, and controls the alignment state of liquid crystal molecules in the pixel area by an electric field obtained between the electrodes. The display panel control circuit includes a gate driver that drives the gate lines, a source driver that drives the source lines, and a controller that controls operational timings of the gate driver and source driver.

In the case where the liquid crystal display device is used for a TV receiver that principally displays a moving image, a liquid crystal display panel of an OCB mode, in which liquid crystal molecules exhibit good responsivity, is generally employed (see Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laid down, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment. A display operation is performed after the initializing process. In addition, the liquid crystal display panel performs an initializing process upon termination of power supply. In this initializing process, too, a relatively strong electric field is applied to the liquid crystal molecules as a countermeasure against persistence of vision.

The reason why the liquid crystal molecules are aligned in the splay alignment before supply of power is that the splay alignment is more stable than the bend alignment in terms of energy in a state where the liquid crystal driving voltage is not applied. As a characteristic of the liquid crystal molecules, the bend alignment tends to be inverse-transferred to the splay alignment if a state where no voltage is applied or a state where a voltage lower than a level at which the energy of splay alignment is balanced with the energy of bend alignment is applied, continues for a long time. The viewing angle characteristic of the splay alignment significantly differs from that of the bend alignment. Thus, a normal display is not attained in this splay alignment.

In a conventional driving method that prevents the inverse transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.” In the meantime, in the black insertion driving, the visibility, which lowers due to retinal persistence occurring on a viewer's vision in a moving image display, is improved by discrete pseudo-impulse response of luminance.

A pixel voltage for black insertion and a pixel voltage for gradation display are applied to all liquid crystal pixels on a row-by-row basis in one frame period, i.e. one vertical scanning period (V). The ratio of a storage period of the pixel voltage for black insertion to a storage period of the pixel voltage for gradation display is a black insertion ratio. In a case where each gate line is driven for black insertion in a half of one horizontal scanning period, i.e. H/2 period, and is driven for gradation display in a subsequent H/2 period, the vertical scanning speed becomes twice higher than in the case where black insertion is not executed. Since the value of the pixel voltage for black insertion is common to all pixels, it is possible to drive, for instance, two gate lines together as a set. In a case where two gate lines of each set are driven together for black insertion in a 2H/3 period, and are sequentially driven for gradation display in a 4H/3 period (2H/3 for each of two gate lines), the vertical scanning speed becomes 1.5 times higher than in the case where black insertion is not executed.

Conventionally, the gate driver is configured to concurrently drive all the gate lines in the initialization for all OCB liquid crystal pixels, which is executed upon supply of power and termination of power supply. In such a configuration, however, a rush current suddenly flows into the gate driver and may cause the gate driver to be damaged. Further, the operation of the power supply unit may be shut down due to the rush current, which is significantly large.

### BRIEF SUMMARY OF THE INVENTION

The object of the present invention is to provide a gate line driving circuit that is capable of dispersing a rush current that flows in initialization of all OCB liquid crystal pixels.

According to the present invention, there is provided a gate line driving circuit which drives a plurality of gate lines assigned to OCB liquid crystal pixels, comprising: a selecting section which selects each of at least two groups obtained by dividing the gate lines; and an output section which outputs driving signals to the gate lines of a group that is selected by the shift register section, the selecting section being configured such that the groups of gate lines are selected at different timings in an initialization for transferring the OCB liquid crystal pixels from a splay alignment to a bend alignment upon supply of power.

With this gate line driving circuit, the selecting section selects the groups of gate lines at different timings in the initialization for transferring the OCB liquid crystal pixels from the splay alignment to the bend alignment upon supply of power. In other words, the gate lines are driven at timings deviated in units of the group. Thus, the rush current to the output section can be dispersed, compared to the case where all the gate lines are driven at a time. In addition, the power supply unit can be protected by dispersion of the rush current.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 schematically shows the circuit configuration of a liquid crystal display device according to an embodiment of the present invention;

FIG. 2 shows in detail a gate line driving circuit of a gate driver shown in FIG. 1; and

FIG. 3 is a time chart that illustrates the operation of the gate line driving circuit shown in FIG. 2 in a case where black insertion driving is executed at a 2× (double) vertical scanning speed in a display mode.

### DETAILED DESCRIPTION OF THE INVENTION

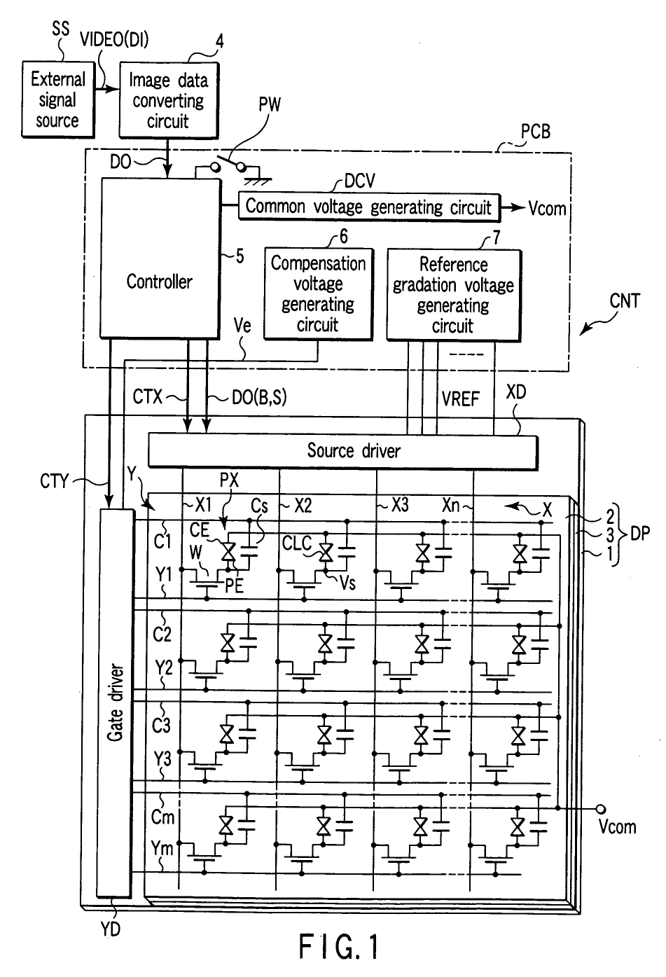

A liquid crystal display device according to an embodiment of the present invention will now be described with reference to the accompanying drawings. FIG. 1 schematically shows the circuit configuration of the liquid crystal display device. The liquid crystal display device comprises a liquid crystal display panel DP and a display panel control circuit CNT that is connected to the display panel DP. The liquid crystal display panel DP is configured such that a liquid crystal layer 3 is held between an array substrate 1 and a counter substrate 2, which are a pair of electrode substrates. The liquid crystal layer 3 contains a liquid crystal material whose liquid crystal molecules are transferred in advance from a splay alignment to a bend alignment usable for a normally-white display, and are prevented from being inverse-transferred from the bend alignment to the splay alignment by a voltage for black insertion (non-gradation display) that is cyclically applied. The display panel control circuit CNT controls the transmittance of the liquid crystal display panel DP by a liquid crystal driving voltage that is applied from the array substrate 1 and counter electrode 2 to the liquid crystal layer 3. The display panel control circuit CNT performs a predetermined initializing process upon supply of power. The splay alignment is transferred to the bend alignment by a relatively strong electric field applied to the liquid crystal layer 3 in the initializing process.

The array substrate 1 includes a plurality of pixel electrodes PE that are arrayed substantially in a matrix on a transparent insulating substrate of, e.g. glass; a plurality of gate lines Y (Y1 to Ym) that are disposed along rows of the pixel electrodes PE; a plurality of storage capacitance lines C (C1 to Cm) that are disposed in parallel to the gate lines Y (Y1 to Ym) along the rows of the pixel electrodes PE; a plurality of source lines X (X1 to Xn) that are disposed along columns of the pixel electrodes PE; and a plurality of pixel switching elements W that are disposed near intersections between the gate lines Y and source lines X, each pixel switching element W being rendered conductive between the associated source line X and associated pixel electrode PE when driven via the associated gate line Y. Each of the pixel switching elements W is composed of, e.g. a thin-film transistor. The thin-film transistor has a gate connected to the associated gate line Y, and a source-drain path connected between the associated source line X and pixel electrode PE.

The counter substrate 2 includes a color filter that is disposed on a transparent insulating substrate of, e.g. glass, and a common electrode CE that is disposed on the color filter so as to be opposed to the pixel electrodes PE. Each pixel electrode PE and the common electrode CE are formed of a transparent electrode material such as ITO, and are coated with alignment films that are subjected to rubbing treatment in directions parallel to each other. To form an OCB liquid crystal pixel PX, each pixel electrode PE and the common electrode CE are associated with a pixel area of the liquid crystal layer 3 which is controlled to have a liquid crystal alignment corresponding to an electric field applied from the pixel electrode PE and common electrode CE.

Each of OCB liquid crystal pixels PX has a liquid crystal capacitance CLC between the associated pixel electrode PE and the common electrode CE. Each of the storage capacitance lines C1 to Cm constitutes storage capacitances Cs by capacitive-coupling to the pixel electrodes PE of the liquid crystal pixels on the associated row. The storage capacitance Cs has a sufficiently large capacitance value, relative to a parasitic capacitance of the pixel switching element W.

In this liquid crystal display device, in order to perform an initialization process in which the display panel control circuit CNT applies a relative large liquid crystal driving voltage to all OCB liquid crystal pixels PX, the liquid crystal display device is set in a non-display mode only for a predetermined period in association with an operation for turning on/off a power supply switch PW. Except for this predetermined period, the display device is set in the display mode. The display panel control circuit CNT includes a gate driver YD that drives the gate lines Y1 to Ym so as to turn on the switching elements W on a row-by-row basis; a source driver XD that outputs pixel voltages Vs to the source lines X1 to Xn in a time period in which the switching elements W on each row are driven by the associated gate line Y; an image data converting circuit 4 that executes, e.g. double-speed (2×) black inserting conversion for image data included in a video signal VIDEO that is input from an external signal source SS; a controller 5 that controls, e.g. operation timings of the gate driver YD and source driver XD in association with the conversion result; and a common voltage generating circuit DCV that generates a common voltage Vcom that corresponds to the display mode and non-display mode. The pixel voltage Vs is a voltage that is applied to the pixel electrode PE with reference to the common voltage Vcom of the common electrode CE. The liquid crystal driving voltage equals to a difference between the pixel voltage Vs and the common voltage Vcom. The polarity of the pixel voltage Vs is reversed, relative to the common voltage Vcom, so as to execute, e.g. line-reversal driving and frame-reversal driving (1H1V reversal driving). The image data is composed of pixel data relating to all liquid crystal pixels PX, and is updated in units of one frame period (vertical scanning period V). In the double-speed black inserting conversion, input pixel data DI for one row are converted in every 1H period to pixel data B for black insertion (non-gradation display) for one row and pixel data S for gradation display for one row, which become output pixel data DO. The pixel data S for gradation display has the same gradation value as the pixel data DI, and the pixel data B for black insertion has a gradation value for black display. Each of the pixel data B for black insertion for one row and the pixel data S for gradation display for one row is serially output from the image data converting circuit 4 in every H/2 period.

The gate driver YD and source driver XD are constructed using thin-film transistors that are formed in the same fabrication steps as, e.g. the switching elements W. On the other hand, the controller 5 is disposed on an outside printed circuit board PCB. The image data converting circuit 4 is disposed further on the outside of the printed circuit board PCB. The controller 5 generates a control signal CTY for selectively driving the gate lines Y, and a control signal CTX that assigns the pixel data for black insertion or gradation display, which are serially output as a conversion result of the image data converting circuit 4, to the source lines X, and designates the signal polarity. The control signal CTY is supplied from the controller 5 to the gate driver YD. The control signal CTX is supplied from the controller 5 to the source driver XD, together with the pixel data DO that is the pixel data B for black insertion or the pixel data S for gradation display, which is obtained as a conversion result of the image data converting circuit 4.

The display panel control circuit CNT further includes a compensation voltage generating circuit 6 and a reference gradation voltage generating circuit 7. The compensation voltage generating circuit 6 generates a compensation voltage Ve that is applied via the gate driver YD to the storage capacitance line C of the row corresponding to switching elements W on one row when the switching elements W on this row are turned off, and that compensates a variation in the pixel voltage Vs, which occurs in the pixels PX on the associated row due to parasitic capacitances of these switching elements W. The reference gradation voltage generating circuit 7 generates a predetermined number of reference gradation voltages VREF that are used in order to convert the pixel data DO to the pixel voltage Vs.

Under the control of the control signal CTY, the gate driver YD selects the gate line, Y1 to Ym, for black insertion in every vertical scanning period, and delivers to the selected gate line Y a driving signal so as to turn on the pixel switching elements W on each row in every H/2 period. Further, the gate driver YD selects the gate line, Y1 to Ym, for gradation display in every vertical scanning period, and delivers to the selected gate line Y a driving signal so as to turn on the pixel switching elements W on each row in every H/2 period. The image data converting circuit 4 alternately outputs the pixel data B for black insertion for one row and the pixel data S for gradation display for one row, which are obtained as the output pixel data DO that are the result of conversion. The source driver XD refers to the predetermined number of reference gradation voltages VREF, which are delivered from the reference gradation voltage generating circuit 7, and converts the pixel data B for black insertion and the pixel data S for gradation display to the pixel voltages Vs and outputs the pixel voltages Vs to the source lines X1 to Xn in parallel.

Assume now that the gate driver YD drives the gate line Y1, for instance, by the driving voltage, and turns on all pixel switching elements W that are connected to the gate line Y1. In this case, the pixel voltages on the source lines X1 to Xn are applied via the pixel switching elements W to the associated pixel electrodes PE and to terminals at one end of the associated storage capacitances Cs. In addition, the gate driver YD outputs the compensation voltage Ve from the compensation voltage generating circuit 6 to the storage capacitance line C1 that corresponds to the other terminals of the associated storage capacitances Cs. Immediately after turning on all pixel switching elements W, which are connected to the gate line Y1, for an H/2 period, the gate driver YD outputs to the gate line Y1 a non-driving voltage that turns off the pixel switching elements W. When the pixel switching elements W are turned off, the compensation voltage Ve reduces the amount of charge that leaks from the pixel electrodes PE to charge the parasitic capacitances of the pixel switching elements W, thereby substantially canceling a variation in pixel voltage Vs, that is, a field-through voltage ΔVp.

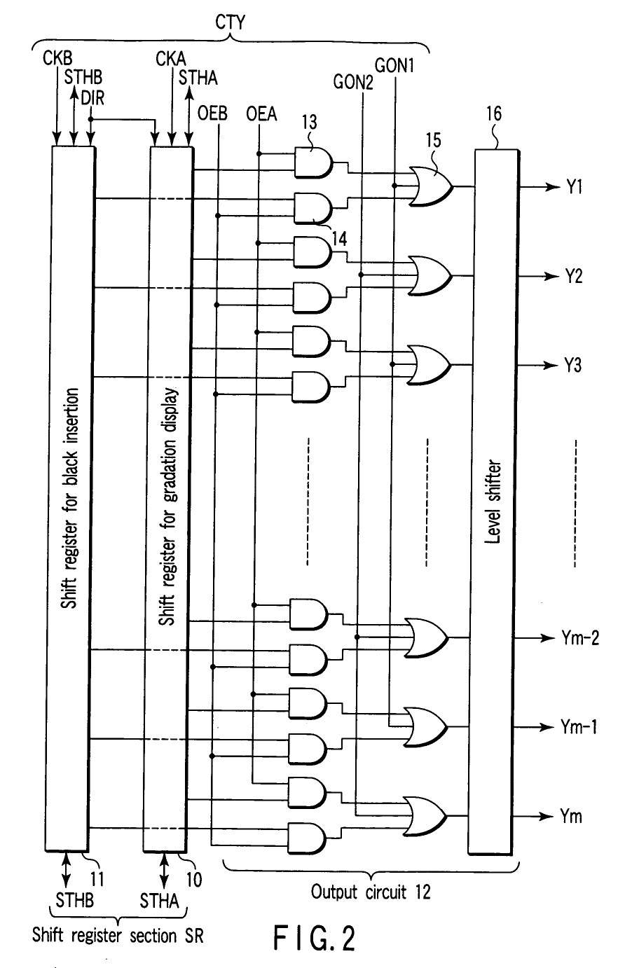

FIG. 2 shows in detail the gate line driving circuit of the gate driver YD. The gate line driving circuit includes a shift register section SR that selects gate lines Y1 to Ym for gradation display and black insertion, and an output circuit 12 that outputs, in the display mode, driving signals to gate lines, which are selected for gradation display and black insertion by the shift register section SR, and outputs, in the non-display mode, driving signals alternately to groups of gate lines Y1 to Ym, which are divided into at least two groups.

Specifically, the shift register section SR comprises a shift register (first shift register) 10 for gradation display, which shifts a first start signal STHA in response to a first clock signal CKA, and a shift register (second shift register) 11 for black insertion, which shifts a second start signal STHB in response to a second clock signal CKB synchronous with the first clock signal CKA. The output circuit 12 is configured to output, in the display mode, a driving signal, under control of a first output enable signal OEA, to the gate line Y that is selected in accordance with the shift position of the first start signal STHA stored in the shift register 10 for gradation display, and a driving signal, under control of a second output enable signal OEB, to the gate line Y that is selected in accordance with the shift position of the second start signal STHB stored in the shift register 11 for black insertion, and to output, in the non-display mode, driving signals alternately to groups of gate lines Y1 to Ym, which are divided into at least two groups. In this example, the gate lines Y1 to Ym are divided into a first gate line group comprising odd-numbered gate lines Y1, Y3, Y5, . . . , and a second gate line group comprising even-numbered gate lines Y2, Y4, Y6, . . . . The first and second groups are selected in series at different timings by a first group selection signal GON1 and a second group selection signal GON2. The first group selection signal GON1, second group selection signal GON2, first clock signal CKA, first start signal STHA, second clock signal CKB, second start signal STHB, first output enable signal OEA and second output enable signal OEB are all included in the control signal CTY that is supplied from the controller 5.

Each of the shift register 10 for gradation display and the shift register 11 for black insertion comprises series-connected m-stages of registers that are assigned to the gate lines Y1 to Ym. The first start signal STHA and second start signal STHB are input to the first-stage registers that are assigned to the gate line Y1. In the shift register 10 for gradation display, the first start signal STHA is shifted from the first-stage register toward the m-th stage register. In the shift register 11 for black insertion, the second start signal STHB is shifted from the first-stage register toward the m-th stage register. Each of all registers in the shift register 10 for gradation display has an output terminal that outputs a selection signal for the associated gate line Y, which rises to a high level while the first start signal STHA is being retained. Each of all registers in the shift register 11 for black insertion has an output terminal that outputs a selection signal for the associated gate line Y, which rises to a high level while the second start signal STHB is being retained.

The output circuit 12 includes an m-number of AND gate circuits 13, an m-number of AND gate circuits 14, an m-number of OR gate circuits (selecting section) 15 and a level shifter (output section) 16. The m-number of AND gate circuits 13 are so connected as to output the selection signals for the gate lines Y1 to Ym, which are obtained from the shift register 10 for gradation display, to the m-number of OR gate circuits 15 under the control of the first output enable signal OEA. The first output enable signal OEA permits all the AND gate circuits 13 to output the selection signals in the state in which the first output enable signal OEA is set at a high level, and the first output enable signal OEA prohibits all the AND gate circuits 13 from outputting the selection signals in the state in which the first output enable signal OEA is set at a low level. The m-number of AND gate circuits 14 are so connected as to output the selection signals for the gate lines Y1 to Ym, which are obtained from the shift register 11 for black insertion, to the m-number of OR gate circuits 15 under the control of the second output enable signal OEB. The second output enable signal OEB permits all the AND gate circuits 14 to output the selection signals in the state in which the second output enable signal OEB is set at a high level, and the second output enable signal OEB prohibits all the AND gate circuits 14 from outputting the selection signals in the state in which the second output enable signal OEB is set at a low level. The m-number of OR gate circuits 15 input the selection signals from the associated AND gate circuits 13 and the selection signals from the associated AND gate circuits 14 to the level shifter 16. Half the OR gate circuits 15 are used for odd-numbered gate lines and input the first group selection signal GON1 to the level shifter 16 as the selection signal for the odd-numbered gate line, Y1, Y3, Y5, . . . . The other half of the OR gate circuits 15 are used for even-numbered gate lines and input the second group selection signal GON2 to the level shifter 16 as the selection signal for the evennumbered gate line, Y2, Y4, Y6, . . . . The level shifter 16 is configured to shift the level of the voltages of the selection signals input from the m-number of OR gate circuits 15, thereby converting the voltages to driving signals that are delivered to the gate lines Y1 to Ym and turn on the thin-film transistors W.

The shift register 10 for gradation display and the shift register 11 for black insertion can shift the first start signal STHA and second start signal STHB not only in a downward direction from the first-stage register toward the m-th stage register, but also in an upward direction from the m-th stage register toward the first-stage register. The directions of shift of the first start signal STHA and second start signal STHB are changed by a scan direction signal DIR that is supplied from the controller 5 to the shift registers 10 and 11.

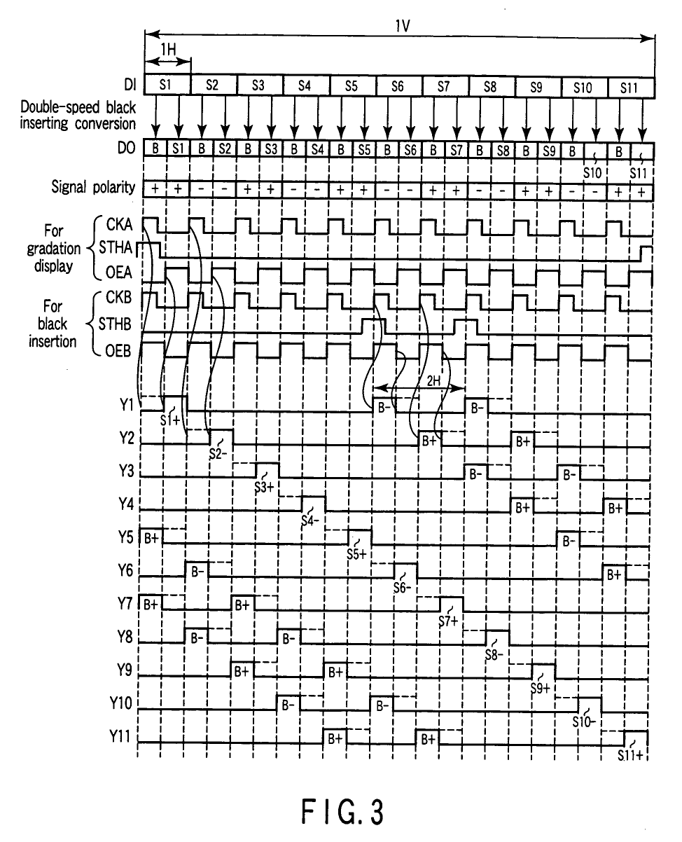

FIG. 3 illustrates the operation of the gate line driving circuit in a case where black insertion driving is executed at double (2×) vertical scanning speed in the display mode. In FIG. 3, symbol B represents pixel data for black insertion, which is common to the pixels PX of the respective rows, and S1, S2, S3, . . . , designate pixel data for gradation display, which are associated with pixels PX on the first row, pixels PX on the second row, pixels PX on the third row, etc. Symbols + and − represent signal polarities at a time when the pixel data B, S1, S2, S3, . . . , are converted to pixel voltages Vs and output from the source driver XD.

The first start signal STHA is a pulse that is input to the shift register 10 for gradation display with a pulse width corresponding to an H/2 period. The first clock signal CKA is a 1H-cycle pulse that is input to the shift register 10 for gradation display at a rate of 1 pulse per 1H period. The shift register 10 for gradation display shifts the first start signal STHA in response to the first clock signal CKA, and outputs the selection signals to sequentially select the gate lines Y1 to Ym in a manner that each gate line remains selected for 1H period. The m-number of AND gate circuits 13 output, under the control of the first output enable signal OEA, the selection signals, which are sequentially obtained from the shift register 10 for gradation display, to the m-number of OR gate circuits 15 in the latter half of every 1H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for gradation display, S1, S2, S3, . . . , to the pixel voltages Vs in the latter half of the associated horizontal scanning period H, and outputs the pixel voltages Vs in parallel to the source lines X1 to Xn with the polarity that is reversed in every 1H period. The pixel voltages Vs are applied to the liquid crystal pixels PX on the first row, second row, third row, . . . , while each of the gate lines Y1 to Ym is driven in the latter half of the associated horizontal scanning period H.

On the other hand, the second start signal STHB is a pulse that is input to the shift register 11 for black insertion with a pulse width corresponding to an H/2 period. The second clock signal CKB is a 1H-cycle pulse that is input to the shift register 11 for black insertion at a rate of 1 pulse per 1H period in sync with the first clock signal CKA. The shift register 11 for black insertion shifts the second start signal STHB in response to the second clock signal CKB, and outputs the selection signals to sequentially select the gate lines Y1 to Ym on a line-by-line basis. The m-number of AND gate circuits 14 output, under the control of the second output enable signal OEB, the selection signals, which are sequentially obtained from the shift register 11 for black insertion, to the m-number of OR gate circuits 15 in the first half of every 1H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for black insertion, B, B, B, to the pixel voltages Vs in the first half of the associated horizontal scanning period H, and outputs the pixel voltages Vs in parallel to the source lines X1 to Xn with the polarity that is reversed in every 1H period. The pixel voltages Vs are applied to the liquid crystal pixels PX on the first row, second row, third row, . . . , while each of the gate lines Y1 to Ym is driven in the first half of the associated horizontal scanning period H. In FIG. 3, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a desired black insertion ratio. In addition, it is preferable to input the second start signal STHB once again with a delay of 2H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of H/2, the pixel voltage Vs can surely be set in the pixel electrode PE. The abovementioned 2H delay is needed in order to uniformize the polarity of the pixel voltages Vs for black insertion. In the meantime, black insertion for the pixels PX near the last row is continuous from the preceding frame, for example, as shown in the lower left part of FIG. 3.

In the non-display mode that is set before and after the above-described display mode operation, the process for initializing all OCB liquid crystal pixels PX is executed. In the initializing process, for example, the first group selection signal GON1 and second group selection signal GON2 are alternately input once. If the first group selection signal GON1 is first input to each of the OR gate circuits 15 for odd-numbered gate lines, the first group selection signal GON1 is delivered to the level shifter 16 as the selection signal for each associated odd-numbered gate line Y. The level shifter 16 converts the selection signals to driving signals and output them to the associated odd-numbered gate lines Y. Thereby, all the odd-numbered gate lines Y1, Y3, Y5, . . . , are driven. During this time, the source driver XD converts pixel data for initialization to pixel voltages Vs, whose values are substantially equal to the value for white display, and outputs the pixel voltages Vs in parallel to all source lines X1 to Xn. At this time, the common voltage Vcom on the common electrode CE side is set so as to obtain a liquid crystal driving voltage, which is necessary for transfer from the splay alignment to bend alignment, as a difference between the common voltage Vcom and the pixel voltage Vs. In this manner, the OCB liquid crystal pixels PX on the odd-numbered rows are initialized in the uniform bend alignment.

Subsequently, if the second group selection signal GON2 is input to each of the OR gate circuits 15 for even-numbered gate lines, the second group selection signal GON2 is delivered to the level shifter 16 as the selection signal for each associated even-numbered gate line Y. The level shifter 16 converts the selection signals to driving signals and output them to the associated even-numbered gate lines Y. Thereby, all the even-numbered gate lines Y2, Y4, Y6, . . . , are driven. During this time, the source driver XD converts pixel data for initialization to pixel voltages Vs, whose values are substantially equal to the value for white display, and outputs the pixel voltages Vs in parallel to all source lines X1 to Xn. At this time, the common voltage Vcom on the common electrode CE side is set so as to obtain a liquid crystal driving voltage, which is necessary for transition from the splay alignment to bend alignment, as a difference between the common voltage Vcom and the pixel voltage Vs. In this manner, the OCB liquid crystal pixels PX on the even-numbered rows are initialized in the uniform bend alignment.

In the present embodiment, the shift register 10 for gradation display and the shift register 11 for black insertion are independently provided. In the display mode, the output circuit 12 outputs, under the control of the first output enable signal OEA, the driving signal to the gate line Y that is selected in accordance with the shift position of the first start signal STHA, and the output circuit 12 outputs, under the control of the second output enable signal OEB, the driving signal to the gate line Y that is selected in accordance with the shift position of the second start signal STHB. By virtue of this structure, in the display mode, the first and second start signals STHA and STHB, the first and second clock signals CKA and CKB, and the first and second output enable signals OEA and OEB may be combined. Thereby, a predetermined number of gate lines can be driven together for black insertion, and a predetermined number of gate lines can sequentially be driven for gradation display. Furthermore, in the non-display mode, the output circuit 12 drives all gate lines Y1 to Ym in units of the group, which is selected by the alternately input first and second group selection signals GON1 and GON2. The odd-numbered gate lines Y1, Y3, Y5, . . . , are selected by the first group selection signal GON1, and the even-numbered gate lines Y2, Y4, Y6, . . . , are selected by the second group selection signal GON2. Compared to the case where all gate lines Y1 to Ym are simultaneously driven, the rush current that flows to the gate driver YD can be dispersed. Thus, the gate driver YD can be protected from the rush current. In addition, by displacing the input timings of the first group selection signal GON1 and second group selection signal GON2 to the OR gate circuits 15, the rush current is dispersedly output from the power supply unit. Therefore, the power supply unit can be protected, compared to the case where the rush current flows all at once.

The present invention is not limited to the above-described embodiment, and various modifications can be made without departing from the spirit of the invention.

For example, in the above-described embodiment, the shift register 10 for gradation display and the shift register 11 for black insertion are provided in the shift register section SR. Alternatively, the shift register section SR may be configured to use a single shift register and to select gate lines Y1 to Ym for gradation display and for black insertion, respectively.

Further, in the above-described embodiment, the gate lines Y1 to Ym are divided into two groups in the non-display mode and driven in units of the group. These gate lines Y1 to Ym may be divided into tree or more groups. In any case, all the groups are driven in series at different timings, and while the gate lines in the same group are simultaneously driven, a liquid crystal driving voltage, which is required for transfer from the splay alignment to bend alignment, is applied to the OCB liquid crystal pixels PX on the associated row.

Moreover, in the above-described embodiment, the gate line driving circuit is used for black insertion driving. The structure of this gate line driving circuit can be used for any purpose other than the black insertion driving if the purpose requires a driving technique for cyclically applying a pixel voltage for non-gradation display to each pixel in addition to a pixel voltage for gradation display.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gate line driving circuit that drives a plurality of gate lines assigned to OCB liquid crystal pixels, comprising:
a selecting section which selects each of at least two groups obtained by dividing said gate lines; and
an output section which outputs driving signals to the gate lines of a group that is selected by said shift register section, said selecting section being configured such that the groups of gate lines are selected at different timings in an initialization for transferring the OCB liquid crystal pixels from a splay alignment to a bend alignment upon supply of power.

2. The gate line driving circuit according to claim 1, wherein said output section is configured to respond to each of at least two group selection signals input in different timings in the initialization and output the driving signals to the gate lines of the associated group.

3. The gate line driving circuit according to claim 2, further comprising a shift register section that selects the gate lines for gradation display and for non-gradation display, and an output circuit that outputs the driving signal to the gate line which is selected by said shift register section, wherein said selecting section and said output section is included in said output circuit.

4. The gate line driving circuit according to claim 3, wherein said shift register section includes a first shift register which shifts a first start signal in response to a first clock signal, and a second shift register which shifts a second start signal in response to a second clock signal synchronous with the first clock signal, the output circuit being configured to output, under control of a first output enable signal, a driving signal to the gate line that is selected by said first shift register, and to output, under control of a second output enable signal, a driving signal to the gate line that is selected by said second shift register.

5. The gate line driving circuit according to claim 3, wherein said output circuit includes:
a plurality of first AND gate circuits, each of which outputs, under control of the first output enable signal, a selection signal for the associated gate line, which is obtained for gradation display from said first shift register;
a plurality of second AND gate circuits, each of which outputs, under control of the second output enable signal, a selection signal for the associated gate line, which is obtained for black insertion from said second shift register;
a plurality of OR gate circuits, each of which outputs the selection signal for the associated gate line, which is input from one of said first AND gate circuits and one of said second AND gate circuits, and also outputs the associated group selection signal as selection signals for the associated gate lines; and
a level shifter that shifts a level of the selection signal, which is output from each of said OR gate circuits, to convert the selection signal to the driving signal.

6. The gate line driving circuit according to claim 4, wherein said OR gate circuits comprise a OR gate circuits for odd-numbered gate lines, which input the first group selection signal to said level shifter as selection signals for the associated odd-numbered gate lines, and OR gate circuits for even-numbered gate lines, which input the second group selection signal to said level shifter as selection signals for the associated even-numbered gate lines.
